(19) United States
(12) Patent Application Publication
(10) Pub. No.: US 2012/0285441 A1
(43) Pub. Date: Nov. 15, 2012

(54) METHOD, SYSTEM AND APPARATUS FOR USAGE WITH A COMMON WATER HEATING SYSTEM

(76) Inventor: Yigal STAROSELSKY, Roshmaain (IL)

(21) Appl. No.: 13/314,884

(22) Filed: Dec. 8, 2011

(30) Foreign Application Priority Data
Aug. 6, 2010 (IL) PCT/IL2010/000450

(51) Int. Cl. F24J 2/42

(52) U.S. Cl. 126/615

(57) ABSTRACT

The present invention describes a method, system and apparatus for optimizing a flow of thermal fluid through one in a multitude of local reservoirs (e.g. water tank) which may have local heating capability and which shares a common water heating source (e.g. solar panels). Keeping a minimal flow from the inlet to the outlet allows a continuous temperature difference monitoring, which is then used to vary the local flow through an automated system, while also taking in consideration the effect of an optional local heating source. The said above may be applied in reverse for cooling systems.

The present invention describe a method, system and apparatus for usage with a common water heating system, wherein, the present invention method, system and apparatus is applied for a Water Heating (WH) systems, when the system is a system that serves for example, a multiple individual clients' water tanks and reservoirs, wherein those water tank reservoirs are connected to the Common Water Heating Source (CWHS), and that CWHS is shared by those individuals, wherein, some of those clients can have an additional Private Water Heating Source (PWHS) which is used to heat water in clients water tank reservoirs in cases where the CWHS is insufficient or does not apply.

Such instance of Water Heating (WH) systems is a Solar Water Heating (SWH), where the CWHS being used is a Solar Receptor (SR), such as in a Solar panel, whether as a common single-stage solution, i.e. thermally transferring heat to fluid or to water, or as a multi-stage solution, e.g. first converting solar energy to electricity and then using this electricity to heat (a central tank of) water.

Though not limited to, an example of one embodiment of the present invention is the widespread common single-stage installations in which the CWHS consists of a centrally shared singularity or plurality of Solar Thermal Collectors (STC), which are normally placed on a shared housing roof and deliver heating to water which circulates by pumping through (commonly spiral heat exchangers in) Private Water Tanks (PWT), each belongs to a single housing unit and which can be additionally or alternatively heated using personal water heating source (PWHS) which are either integrated into the PWT (as in the majority of installations in Israel for example) or concatenated after the PWT and is sometimes referred to as a “backup” water heating system (as in the majority of installations in Southern California for example). In any case, whether excluded, integrated or concatenated, it is forming a functional unit which can be called the Privately Heated Water Tank (PHWT).

The current invention and its application first come to alleviate the inherent flaw and optimally solve the issue of heat dissipation in the system by basically automating the process of connecting or disconnecting a client from the solar circuit as needed by means of a valve changing its state in inverse relation to the state of private heating (when applicable), i.e. basically when the private heating is switched on—the solar outlet valve is being shut (closed/off), and when the PWHS is switched off—the solar outlet valve is being released (opened/on).

To further utilize the system (including when private heating is not applicable), the temperature difference between the PHWT's solar circuit inlet and outlet is being read, and the final state of the valve is set to open (released/on) only if the PWHS is switched off (or does not apply) and the inlet temperature is higher than the outlet temperature, otherwise the valve is shut (closed/off). To allow reading both temperatures continuously (i.e. even when the valve is shut), a minimal flow in the solar circuit is kept. It is interesting to note that when the pump is idle, the thermo-siphoning effect will cause the outlet to be warmer than the inlet, and so the valve will be shut and the logic kept intact.

Wherein, the method, system and apparatus for usage with a common water heating source, such as solar collectors, that are connected to the Private Water Tanks (PWT), and to enable, or disable the connection of such Private Water Tanks (PWT) from the common heating source and system, wherein, the disconnecting of the Private Water Tanks (PWT) from the Common Water Heating Source (CWHS) designated to enable the Private Water Tanks (PWT), from being influenced by the common system, effectively enabling a client installation in such a common system to operate as if it was an independent stand alone system, with the benefit of minimizing energy dissipation out to the common system.

Wherein, the system incorporates a micro controller with three main inputs and one main output.

Wherein, the Inputs comprised: 1. the on/off state of the PWHS (set to ‘off’ when is not applicable) 2. The temperature of the tank's solar circuit's inlet 3. The temperature of the tank's solar circuit's outlet. Wherein, the PWHS's on/off state is logical, and can be related either to the user control as in a physical on/off switch (thus using a dry contact), to the built-in thermostat state actual heating on/off (thus using a high voltage relay or an optocoupler) or to another given threshold value or state (thus using control over an A2D input).

The temperatures are being sensed using thermistors fed to inputs. It is also possible to set the minimum delta-T of the inlet above the outlet to be considered “higher”. It is possible to replace the thermistors with fixed resistors or software to bypass temperature reading and correlate only to the PWHS state. It is possible to set software minimum temperatures for activation. In a fallback case where both thermistors indicate a value below minimum (both cold)—the valve is closed, when both indicate a value above maximum (both hot)—the valve is opened (unless the PWHS is on). When one of the thermistors is invalid (or any other total control fail)—the valve is set to a predefined state (commonly opened).

Wherein, the Output is controlling the valve's state. The valve control can be traditionally implemented using a standard 2-way actuated motorized, solenoid or other electromechanically controlled valve. For example, in case of an actuated 5 v motorized edge-auto-stopping valve using 3 wires it is simple to use two TTL outputs, one for commencing open, one for close. If monitoring of motor state is needed, electrical current or voltage from the relevant wire(s) can be fed into the controller's input.

### FIELD of the INVENTION

This invention relates to method, system and apparatus for usage with a common water heating system and in particular to enable, or disable the connection of such Private Water Tanks (PWT) and personal water heating source (PWHS), from the common water heating source and system, and effectively enabled them to act as an independent and not influenced from the optional connection to common water heating source system.

### BACKGROUND OF THE INVENTION

At first quick look, such a shared application might seem an optimal condition, but it suffers from an inherent flaw. Since all the PHWT are sharing a thermal exchange flow (the closed solar heating circuit)—heat which is privately applied (using in-house electricity, gas, etc) or accumulated within time (thanks to the common heat source) is condemned to dissipate, outflow and re-circulate into the shared solar circuit, eventually to be mostly fed into all the other PHWT (or PWT) which share that circuit—with three undesired side-effects: (a) Frustrating un-accomplishment (not having hot water), (b) Time-consuming (the need to repeat or continue heating in the hope that the incident will not recur) and (c) Squander (loss of money for idle private heating), i.e.—original heating of water in a private PHWT by a private consumer (housing/commercial unit tenant) who is paying for the underlying resources—was drawn out and used by other tenant(s) in other housing/commercial unit(s) before or during the originator's righteous intention and usage of it.

Many geographical are utilizing available alternative means of energy for the application of water heating. One such solution in places blessed with sufficient sunlight is the usage of Solar Thermal Collectors (STC) to transfer heat to water circulating through a PWT by means of thermo-siphoning or pumping. In a substantial number of locations that are subject to seasonal differences, or during a malfunction, or simply when the heating rate might not be enough to satisfy demand, a PHWT is being used rather than just a PWT. In such a configuration there are four water connections to the PHWT: one inlet and outlet are connected to the collectors—forming the (closed) solar heating circuit. The (open) in-house circuit is formed by the other inlet being connected or forked from the housing cold water mains and the other outlet being connected to the housing hot water mains (which is eventually where the housing unit's hot water supply comes from).

Although the majority of installations consist of private STC and PWT/PHWT, a very substantial percentage of installations in shared and commercial housing consists of a shared STC connected to a plurality of PWT/PHWT using pumping that allows the placement of the private tanks/boilers within the housing units, resulting in a substantially increased roof area that makes it possible to place additional collectors, electricity producing solar panels, gardens or additional housing units (e.g. penthouses), etc. . . . or when it's simply a design, construction, juridical or another constraint.

Available Solutions, other than social engineering and creative timing, the only technical solution is applicable where the PHWT's are located in the private premises, allowing the existence and usage of a manual valve at the inlet or outlet of the PHWT's solar circuit to temporarily shut its flow before privately heating the water, and releasing it after usage. There are several frequent problems with this “solution”: (a) Danger—the valve's location is beyond the safe reach of people, especially elderly and children, (b) Inconvenience—the valve's location is hard or out of reach due to the specific placement of the PHWT which can even be placed in normally hidden cavities to promote aesthetic value or usable area, or even outside the premises in a designated area (c) Lack of comfort or sheer laziness and (d) Forgetfulness.

Even when possible, since two interactions with the valve are needed for each session (shutting and releasing), it is common that the valve would be erroneously left in one of two states and therefore cause either: (a) When left shut—The inability to enjoy the free prior heating from the solar circuit, or (b) When left open—the three undesired side-effects described above.

It is the present invention objective to enable a method, system and apparatus for controlling the participation of Private Water Tanks (PWT/PHWT) within a common water heating source, and in particular to enable, or disable the connection of such Private Water Tanks (PWT/PHWT) from/to the common water heating source and system, and effectively render them as an emulation of an independent installation not influenced from the optional connection to the common water heating source and system.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention but not to limit the invention to these descriptions only.

This invention relates to method, system and apparatus that enables controlling upon the automated optimized connection and disconnection of a Private Water Tanks (PWT/PHWT) from/to the common water heating source system, enabling the private installations to be connected to the solar circuit or disconnected from it, in which it either preserves its energy and/or gets further energy from its independed backup energy source, disabling the connecting of such common water heating source and system, from the Private Water Tanks (PWT), and personal water heating source (PWHS), and enabled them as an in depended system, not influenced from the optional connection to the common water heating source and system.

method, system and apparatus of the present invention displays an automatic operational system controlling the connection to the common water heating source and system, such as a sun collectors (SWH), that is a system that connected to a plurality of an individual water reservoirs, that optionally have a backup source of energy, and enables, or disables the connection or the disconnection of the individual water reservoir to/from such common water heating source and system, enabling the individual reservoir (water tank) to be an independent system from the common water heating source system, and not to be influenced from undesirable influence from that common system, wherein the system comprising:
a. a micro controller with three main inputs and one main output.

Inputs:
1. The on/off state of the PWHS (optional and thus set ‘off’ if not applicable)
2. The temperature of the tank's solar circuit's inlet
3. The temperature of the tank's solar circuit's outlet

Wherein, the PWHS's on/off state is logical, and can be related either to the user control as in a physical on/off switch (thus using a dry contact), to the built-in thermostat state actual heating on/off (thus using a high voltage relay or an optocoupler) or to another given threshold value or state (thus using control over an A2D input).

Wherein, temperatures are being sensed using thermistors fed to A2D inputs. It is also possible to set the minimum delta-T of the inlet above the outlet to be considered “higher”. It is possible to replace the thermistors with fixed resistors or software to bypass temperature reading and correlate only to the PWHS state. It is possible to set software minimum temperatures for activation. In a fallback case where both thermistors indicate a value below minimum (both cold)—the valve is closed, when both indicate a value above maximum (both hot)—the valve is opened (unless the PWHS is on). When one of the thermistors is invalid (or any other total control fail)—the valve is set to a predefined state (commonly opened).

Output:

The output is controlling the valve's state. The valve control can be traditionally implemented using a standard 2-way actuated motorized, solenoid or other electromechanically controlled valve. For example, in case of an actuated 5 v motorized edge-auto-stopping valve using 3 wires it is simple to use two TTL outputs, one for commencing open, one for close. If monitoring of motor is state is needed, electrical current or voltage from the relevant wire(s) can be fed into the controller's input.

A Constant Minimal Solar Circuit Flow must be maintained when the valve is closed in order to keep reading temperature, thus:
1. Using a bypass pipe over the valve. The bypass pipe's passage is very narrow and allows only a miniscule amount of fluid to flow. It is also possible to have a T-pipe bypass arrangement to have one of the thermistors embedded into it.
2. Using motorized valve, it is possible to leave the valve slightly opened (for example, by letting it shut completely then shortly open it).

Some Power Supply Options might be:
1. Using transformer from nearby power outlet
2. Using batteries
3. Using transformer from power input to the PHWT with rechargeable batteries
4. Using solar panels to recharge batteries

This invention relates to Method, system and apparatus for is controlling a common water heating source system, such as a sun collectors (SWH), that are system that connected to the individual water tanks, and to enable, or disable the connection from/to such common water heating source and system, by blocking it or letting it pass through the individual water reservoir, wherein, the disconnecting of the individual reservoir (water tank) from the Common Water Heating Source (CWHS) designated to enable the Private Water Tanks (PWT) to operate and maintain their energy to the benefit of the individual reservoir (water tank), virtually eliminating unnecessary energy dissipation out to the common system.

### BRIEF DESCRIPTION OF THE DRAWINGS

The accompanying drawings, which are incorporated in and form a part of this specification, illustrate embodiments of the invention and together with the description, serve to explain by way of example only, the principles of the invention:

FIG. 1 is a schematic illustrating of the Method, system and apparatus for controlling common water heating source system

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

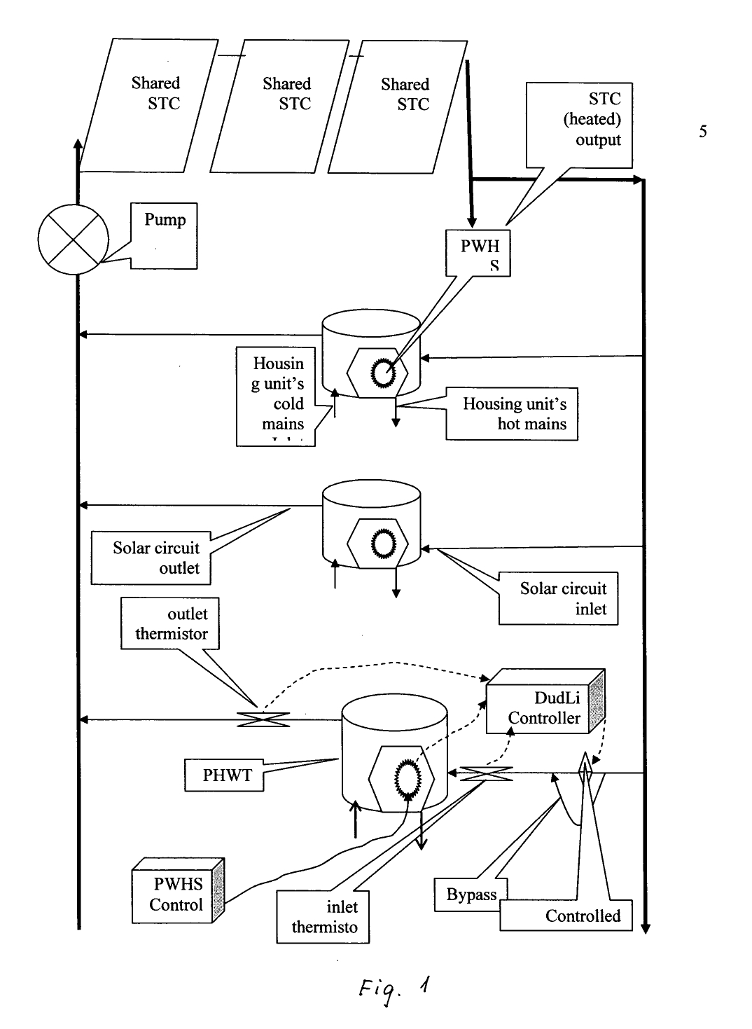

FIG. 1 is an illustration of one embodiment of the present invention, illustrating a schematic illustrating of the Method, system and apparatus for controlling common water heating source system

### The Current Invention

The current invention and its application first come to alleviate the inherent flaw of heat dissipation and optimally solve this issue by basically automating the process of changing the valve's state in inverse relation to the state of private heating (when applicable), i.e. basically when the private heating is switched on—the solar outlet valve is being shut (closed/off), and when the PWHS is switched off—the solar outlet valve is being released (opened/on).

To further utilize the system (and regardless to the existence of the PWHS), the temperature difference between the PHWT's solar circuit inlet and outlet is being read, and the final state of the valve is set to open (released/on) only if the PWHS is switched off and the inlet temperature is higher than the outlet temperature, otherwise the valve is shut (closed/off). To allow reading both temperatures continuously (i.e. even when the valve is shut), a minimal flow in the solar circuit is kept. It is interesting to note that when the pump is idle, the thermo-siphoning effect will cause the outlet to be warmer than the inlet, and so the valve will be shut and the logic kept intact.

### A Technical Example of an Implementation

The system incorporates a micro controller with three main inputs and one main output.

### Inputs:

1. The on/off state of the PWHS
2. The temperature of the solar circuit's inlet
3. The temperature of the solar circuit's outlet

Note that the PWHS's on/off state is logical, and can be related either to the user control as in a physical on/off switch (thus using a dry contact), to the built-in thermostat state actual heating on/off (thus using a high voltage relay or an optocoupler) or to another given threshold value or state (thus using control over an A2D input).

Temperatures are being sensed using thermistors fed to A2D inputs. It is also possible to set the minimum delta-T of the inlet above the outlet to be considered “higher”. It is possible to replace the thermistors with fixed resistors or software to bypass temperature reading and correlate only to the PWHS state. It is possible to set software minimum temperatures for activation. In a fallback case where both thermistors indicate a value below minimum (both cold)—the valve is closed, when both indicate a value above maximum (both hot)—the valve is opened (unless the PWHS is on). When one of the thermistors is invalid (or any other total control fail)—the valve is set to a predefined state (commonly opened).

### Output:

The output is controlling the valve's state. The valve control can be traditionally implemented using a standard 2-way actuated motorized, solenoid or other electromechanically controlled valve. For example, in case of an actuated 5 v motorized edge-auto-stopping valve using 3 wires it is simple to use two TTL outputs, one for commencing open, one for close. If monitoring of motor state is needed, electrical current or voltage from the relevant wire(s) can be fed into the controller's input.

### Example of Control Core Logic in Pseudo-Code:

@Start:

PHWT = GetLogicState(InPortA);
InT = GetTemperature(InPortB);
OutT = GetTemperature(InPortC);
If (!IsValid(PHWT) || !IsValid(InT) || !IsValid(OutT))
{

TriggerError( );
BackgroundSetValve(FALLBACK_POSITION);
Goto @Start;

}
If (!PHWT && (InT > OutT || (InT > MaxT && OutT > MaxT)))
{

BackgroundSetValve(OPEN_POSITION);

}
Else
{

BackgroundSetValve(CLOSE_POSITION);

}
Goto @Start;

### Constant Minimal Solar Circuit Flow:

There are numerous possibilities, here are two examples:
1. Using a bypass pipe over the valve. The bypass pipe's passage is very narrow and allows only a miniscule amount of fluid to flow. It is also possible to have a T-pipe bypass arrangement to have one of the thermistors embedded into it.
2. Using motorized valve, it is possible to leave the valve slightly opened (for example, by letting it shut completely then shortly open it).

### Some Power Supply Options:

1. Using transformer from nearby power outlet
2. Using batteries
3. Using transformer from power input to the PHWT with rechargeable batteries
4. Using solar panels to recharge batteries
   Extended Outputs to be Used with Another System or a (Modular Mountable) User Display/Input Panel:
1. PWHS's logical/physical state
2. Temperature readings
3. Valve state
4. Status, Alerts and Errors
   Extended Inputs to be Used as Built-in Controls or with Another System or a (Modular Mountable) User Display/Input:
1. Set PWHS's state
2. Bypass thermistors
3. Valve manual override
4. Set inlet>outlet delta-T
5. Set minimum inlet activation temperature
6. Set fallback state
7. Set PWHS's timer(s) with desired-temperature.

### Concluding Notes:

1. Though the system described is used for water heating, it is completely simple and feasible to adapt it to a water cooling system simply by swapping the inlet and outlet temperature inputs.
2. Although uncommon in shared configurations, the same application is applicable without any changes to an open thermo-siphoning solution.

What is claimed is:

1. An automatic operational system controlling the behavior of a common water heating source system, such as a sun collectors, that is a system that connected to a plurality of an individual water reservoirs, that optionally have a backup source of energy, and enables, or disables the connection or the disconnection of the individual water reservoir from/to such common water heating source and system, enabling the individual reservoir (water tank) to act as an independent system, and not to be influenced by undesirable effects from that common system, wherein the system comprising:
a. a micro controller with three main inputs and one main output.
Inputs:
a.1. optional on/off state of the PWHS where applicable
a.2. The temperature of the tank's solar circuit's inlet
a.3. The temperature of the tank's solar circuit's outlet
Wherein, the PWHS's on/off state is logical, and can be related either to the user control as in a physical on/off switch (thus using a dry contact), to the built-in thermostat state actual heating on/off (thus using a high voltage relay or an optocoupler) or to another given threshold value or state (thus using control over an A2D input).
Wherein, temperatures are being sensed using thermistors fed to A2D inputs. It is also possible to set the minimum delta-T of the inlet above the outlet to be considered “higher”. It is possible to replace the thermistors with fixed resistors or software to bypass temperature reading and correlate only to the PWHS state. It is possible to set software minimum temperatures for activation. In a fallback case where both thermistors indicate a value below minimum (both cold)—the valve is closed, when both indicate a value above maximum (both hot)—the valve is opened (unless the PWHS is on). When one of the thermistors is invalid (or any other total control fail)—the valve is set to a predefined state (commonly opened).
Output:
The output is controlling the valve's state. The valve control can be traditionally implemented using a standard 2-way actuated motorized, solenoid or other electromechanically controlled valve. For example, in case of an actuated 5 v motorized edge-auto-stopping valve using 3 wires it is simple to use two TTL outputs, one for commencing open, one for close. If monitoring of motor state is needed, electrical current or voltage from the relevant wire(s) can be fed into the controller's input.
b. A Constant Minimal Solar Circuit Flow:
b.1. Using a bypass pipe over the valve. The bypass pipe's passage is very narrow and allows only a miniscule amount of fluid to flow. It is also possible to have a T-pipe bypass arrangement to have one of the thermistors embedded into it.
b.2. Using motorized valve, it is possible to leave the valve slightly opened (for example, by letting it shut completely then shortly open it).
c. Some Power Supply Options:
c.1. Using transformer from nearby power outlet
c.2. Using batteries
c.3. Using transformer from power input to the PHWT with rechargeable batteries
c.4. Using solar panels to recharge batteries

2. The system described in claim 1 wherein, the connecting or the disconnecting of the two systems is due the temperature differences between the common water heating source system temperature and the Private Water Tanks temperature.

3. The system of claim 1 further comprising a Control Core Logic in Pseudo-Code:
@Start:
PHWT = GetLogicState(InPortA);
InT = GetTemperature(InPortB);
OutT = GetTemperature(InPortC);
If (!IsValid(PHWT) || !IsValid(InT) || !IsValid(OutT)) {
TriggerError( );
BackgroundSetValve(FALLBACK_POSITION);
Goto @Start;
}
If (!PHWT && (InT > OutT || (InT > MaxT && OutT > MaxT)))
{
BackgroundSetValve(OPEN_POSITION);
}
Else
{
BackgroundSetValve(CLOSE_POSITION);
}
Goto @Start;

4. The system of claim 1 further comprising an extended outputs to be used with another system or a (modular mountable) user display/input panel:
a. PWHS's logical/physical state
b. Temperature readings
c. Valve state
d. Status, Alerts and Errors

5. The system of claim 1 further comprising an extended inputs to be used as built-in controls or with another system or a (modular mountable) user display/input:
a. Set PWHS's state
b. Bypass thermistors
c. Valve manual override
d. Set inlet>outlet delta-T
e. Set minimum inlet activation temperature
f. Set fallback state
g. Set PWHS's timer(s) with desired-temperature.

6. The system of claim 1 further wherein, the system described as used for water heating, is completely simple and sufficient to adapt it to a cooling system by swapping the inlet and outlet temperature inputs.

7. The system of claim 1 wherein the systems comprising: a. common thermal source and b. multitude of private accumulators for the said source with or without a private backup.

8. The system of claim 1 wherein the use of the system can be used by the application of pressured gas storage for release of energy converted to electricity.

9. The system of claim 1 wherein thus, the common thermal source doesn't limited to solar panels, it can be an electric common source, nuclear common source, geothermal common source, etc.

10. The system of claim 1 wherein and the private accumulation device doesn't have to be limited to a water boiler, it can be a pressure gas tank.

11. The system of claim 1 wherein the backup system is not limited to electrical unit, and can be any one used for such application (e.g. gas burning)

12. The system of claim 1 further comprising the backup system that its sensing abilities are not limited to electrical current sensing, but can work on radio waves, infra-red reading, etc.

13. The system of claim 1 further comprising the valve being used to close the circuit is not limited to a motorized ball-valve and can be any device to give this effect (a solenoid valve for e.g.)

14. The system of claim 1 further comprising the specific usage of a valve which can leave a small opening, and has the advantage of not needing a small bypass to keep little water running for continuous readout of temperature.

15. The system of claim 1 wherein the system can be standalone or embedded in several ways within an existing devices, e.g. embedded in the boiler itself, or embedded in the VALVE itself.

16. The system of claim 1 wherein the system incorporates a battery to store energy from the backup heater (when it's open) for two main uses: a. emergency, b. bypass need of external ac voltage.

17. The system of claim 1 further comprising auxiliary connections to the system that include optional networked communication, including but not limited, intra, internet, where the main logic can be shifted or distributed to be located in an external host and let the system listen to or to co-operate-with external commands, e.g. schedules and timers, monitoring, reporting, co-operation with other devices and appliances.

18. A method that enables an automatic controllers that connects or disconnects an individual water reservoirs, that optionally have a backup source of energy, from a common water heating source such as from a sun collectors system, that connected to a plurality of individual water reservoirs, wherein the system comprising:
a. a micro controller with three main inputs and one main output.
Inputs:
a.1. The on/off state of the PWHS
a.2. The temperature of the solar circuit's inlet
a.3. The temperature of the solar circuit's outlet
Wherein, the PWHS's on/off state is logical, and can be related either to the user control as in a physical on/off switch (thus using a dry contact), to the built-in thermostat state actual heating on/off (thus using a high voltage relay or an optocoupler) or to another given threshold value or state (thus using control over an A2D input).
Wherein, temperatures are being sensed using thermistors fed to A2D inputs. It is also possible to set the minimum delta-T of the inlet above the outlet to be considered “higher”. It is possible to replace the thermistors with fixed resistors or software to bypass temperature reading and correlate only to the PWHS state. It is possible to set software minimum temperatures for activation. In a fallback case where both thermistors indicate a value below minimum (both cold)—the valve is closed, when both indicate a value above maximum (both hot)—the valve is opened (unless the PWHS is on). When one of the thermistors is invalid (or any other total control fail)—the valve is set to a predefined state (commonly opened).
Output:
The output is controlling the valve's state. The valve control can be traditionally implemented using a standard 2-way actuated motorized, solenoid or other electromechanically controlled valve. For example, in case of an actuated 5 v motorized edge-auto-stopping valve using 3 wires it is simple to use two TTL outputs, one for commencing open, one for close. If monitoring of motor state is needed, electrical current or voltage from the relevant wire(s) can be fed into the controller's input.
b. A Constant Minimal Solar Circuit Flow:
b.1. Using a bypass pipe over the valve. The bypass pipe's passage is very narrow and allows only a miniscule amount of fluid to flow. It is also possible to have a T-pipe bypass arrangement to have one of the thermistors embedded into it.
b.2. Using motorized valve, it is possible to leave the valve slightly opened (for example, by letting it shut completely then shortly open it).
c. Some Power Supply Options:
c.1. Using transformer from nearby power outlet
c.2. Using batteries
c.3. Using transformer from power input to the PHWT with rechargeable batteries
c.4. Using solar panels to recharge batteries.
